(19) United States
(12) Patent Application Publication
(10) Pub. No.: US 2025/0164931 A1
(43) Pub. Date: May 22, 2025

(54) HOROLOGICAL KARUSSEL COMPRISING TWO BALL BEARINGS

(71) Applicant: Blancpain SA, Le Brassus (CH)

(72) Inventors: Bernat MONFERRER, St-Prex (CH); Cédric REYMOND, Les Bioux (CH)

(73) Assignee: Blancpain SA, Le Brassus (CH)

(21) Appl. No.: 18/953,809

(22) Filed: Nov. 20, 2024

(30) Foreign Application Priority Data
Nov. 21, 2023 (EP) 23211272.2

(51) Int. Cl. G04B 17/28; G04B 31/00

(52) U.S. Cl. CPC G04B 17/285; G04B 31/00

(57) ABSTRACT

A karussel for a horological movement, the karussel including an inertial mass, a guide and a resilient return element for returning the inertial mass, configured to cause it to oscillate in a plane, as well as an escapement mechanism cooperating with the inertial mass, the karussel including a carriage intended to be rotatable, the inertial mass, the guide, the resilient return element and the escapement mechanism being arranged inside the carriage, the karussel including a first ball bearing allowing the carriage to rotate, when mounted in a horological movement, and a second ball bearing allowing the escapement mechanism to be actuated, the first ball bearing and the second ball bearing being arranged substantially in the same plane. A horological movement can include such a karussel, and a timepiece can include such a horological movement.

### TECHNICAL FIELD OF THE INVENTION

The invention relates to the field of karussels for horological movements, which karussels comprise two ball bearings.

The invention further relates to a horological movement comprising such a karussel, as well as to a timepiece comprising such a movement.

### TECHNOLOGICAL BACKGROUND

Most mechanical watches today are equipped with a regulating member comprising a sprung balance and a Swiss lever escapement mechanism. The sprung balance constitutes the time base of the watch. It is also referred to as a resonator.

The escapement has two main functions:
to maintain the two-and-fro motions of the resonator;
to count these to-and-fro motions.

An inertial mass, a guide and a resilient return element are required in order to constitute a mechanical resonator. Conventionally, a balance spring acts as a resilient return element for the inertial mass constituted, for example, by a balance. This balance is guided in rotation by pivots which rotate inside plain ruby bearings.

In order to reduce the undesirable effects of gravity on the motion of the regulating member, complications of the tourbillon or karussel type exist, which cause the regulating member to rotate about an axis. These complications also have a particular aesthetic appeal, which makes the timepiece singularly attractive.

In a tourbillon, the escapement mechanism and the carriage rotation mechanism are arranged in series. Generally speaking, the means for driving the movement actuate the rotation of the carriage, and the rotation of the carriage in turn causes the escapement mechanism to be actuated. The escapement mechanism meshes with a fixed wheel of the movement in order to be actuated.

A karussel works differently, as the actuation of the carriage rotation and the actuation of the escapement mechanism are produced in parallel by the drive means. Therefore, unlike a tourbillon, the escapement mechanism can operate even if the carriage is prevented from rotating, albeit at a different frequency.

Moreover, to prevent the carriage from idling when unloading the barrel, the karussel comprises a retaining gear train, which retains the carriage.

In the case of a karussel, the carriage typically has a toothing, for example a peripheral toothing, which meshes with a first gear train that can be actuated by the barrel.

To allow the carriage to rotate, tourbillons or karussels exist with a ball bearing connecting the carriage to an armature of the regulating member, so that the carriage can rotate relative to the armature.

The escapement mechanism typically comprises an intermediate wheel set driven by a second gear train capable of being actuated by the barrel. The intermediate wheel set comprises a pinion arranged under the carriage and a rotary arbor on which the pinion is mounted. The arbor is held in bearings at its ends, allowing it to rotate and drive the intermediate wheel set.

However, such a karussel is very thick, requiring a movement and a timepiece of sufficient size to accommodate it. This feature thus prevents it from being integrated into certain smaller movements or at least into thin movements, or into movements with a particular configuration.

### SUMMARY OF THE INVENTION

The aim of the invention is to overcome the aforementioned drawbacks, and to provide a karussel of smaller thickness compared with karussels of the prior art.

To this end, the invention relates to a karussel for a horological movement, which karussel comprises an inertial mass, a guide and a resilient return element for returning the inertial mass, configured to cause it to oscillate in a plane, as well as an escapement mechanism cooperating with the inertial mass, the karussel comprising a carriage intended to be mounted rotatably, the inertial mass, the guide, the resilient return element and the escapement mechanism being arranged inside the carriage, the karussel comprising a first ball bearing allowing the carriage to rotate, when mounted in a horological movement, and a second ball bearing allowing the escapement mechanism to be actuated.

The movement is characterised in that the first ball bearing and the second ball bearing are arranged substantially in the same plane.

As a result, the karussel is thinner, as the second ball bearing eliminates the need for bearings at the ends of the arbor of the intermediate wheel set, resulting in the karussel occupying less space. Moreover, because the two ball bearings are in the same plane, the karussel is even thinner.

Thanks to the invention, such a karussel can be adapted to smaller, in particular thinner, movements.

According to a particular embodiment of the invention, the first ball bearing and the second ball bearing are coaxial.

According to a particular embodiment of the invention, the second ball bearing is arranged concentrically inside the first ball bearing.

According to a particular embodiment of the invention, the karussel comprises a bearing support comprising the first ball bearing and the second ball bearing.

According to a particular embodiment of the invention, the bearing support is arranged under the carriage.

According to a particular embodiment of the invention, the carriage comprises an upper armature and a lower armature, with the bearing support arranged beneath the lower armature.

According to a particular embodiment of the invention, the bearing support comprises a first element, preferably an external element, intended to be mounted integral with the carriage.

According to a particular embodiment of the invention, the bearing support comprises a second element, preferably an intermediate element, intended to be mounted integral with the plate of the movement.

According to a particular embodiment of the invention, the bearing support comprises a third element, preferably an internal element, intended to be mounted integral with an arbor actuating the escape mechanism.

According to a particular embodiment of the invention, the first element and the second element are connected by the first ball bearing.

According to a particular embodiment of the invention, the third element and the second element are connected by the second ball bearing.

According to a particular embodiment of the invention, the first element, the second element and the third element are arranged in the same plane as the first ball bearing and the second ball bearing.

The invention further relates to a horological movement comprising a plate configured to support the other parts of the movement, the horological movement comprising drive means provided with a gear train, and such a karussel.

According to a particular embodiment of the invention, the karussel is mounted at an angle to the plate.

The invention further relates to a timepiece comprising such a horological movement.

### BRIEF DESCRIPTION OF THE FIGURES

The purposes, advantages and features of the present invention will become apparent after reading several embodiments, which are provided for purposes of illustration only and not intended to limit the scope of the invention, given with reference to the accompanying drawings, wherein:

FIG. 1 diagrammatically shows a side view of a part of a first embodiment of a horological movement comprising a karussel according to the invention,

FIG. 2 diagrammatically shows a perspective, top view of the part of the horological movement in FIG. 1,

FIG. 3 diagrammatically shows a perspective, bottom view of one embodiment of the karussel according to the invention,

FIG. 4 diagrammatically shows a perspective, top view of the embodiment of the karussel according to the invention,

FIG. 5 diagrammatically shows a top view of the embodiment of the karussel according to the invention,

FIG. 6 diagrammatically shows a top view of the embodiment of the karussel according to the invention,

FIG. 7 diagrammatically shows a sectional view of the embodiment of the karussel according to the invention,

FIG. 8 diagrammatically shows a perspective, top view of a part of a second embodiment of a horological movement comprising a karussel according to the invention,

FIG. 9 diagrammatically shows a perspective, top view of a part of the horological movement in FIG. 8, and

FIG. 10 diagrammatically shows a perspective, bottom view of a part of the horological movement in FIG. 8.

### DETAILED DESCRIPTION OF THE INVENTION

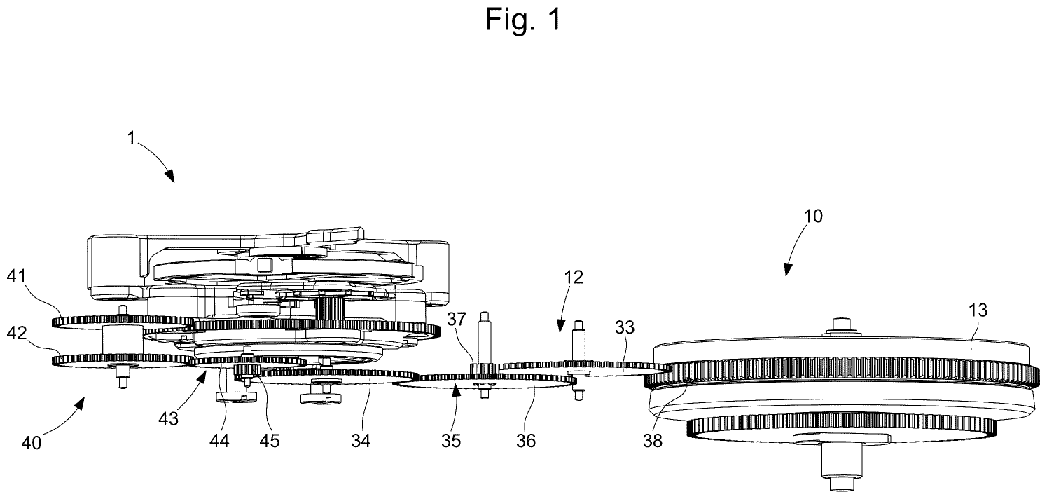

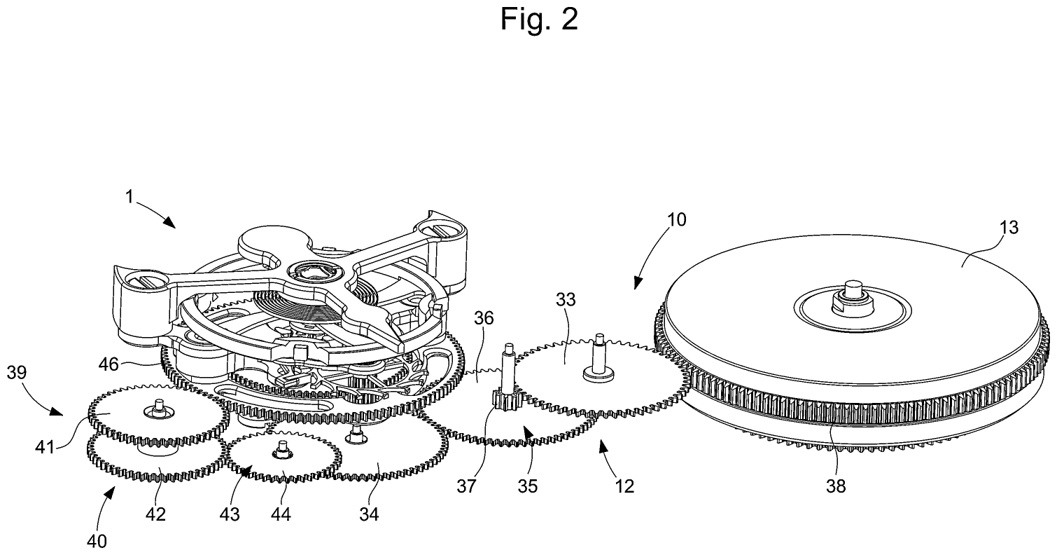

The invention relates to a karussel 1 intended to be mounted in a horological movement 10, a first embodiment of such a horological movement 10 being shown in part in FIGS. 1 and 2. Such a horological movement 10 typically comprises a plate (not shown in the figures), which extends substantially in one plane, the plate being configured to support parts of the horological movement 10. In this embodiment, the karussel 1 is mounted flat on the plate.

Moreover, the horological movement 10 includes drive means comprising a barrel 13 and a gear train 12 connecting the barrel 13 to the karussel 1.

In this embodiment, the gear train 12 comprises two gear wheels 33, 34 and a gear wheel set 35 combining a wheel 36 and a gear pinion 37 which are stacked. A first wheel 33 is driven by the outer toothing 38 of the barrel 13, and meshes with the gear pinion 37 of the gear wheel set 35. The wheel 36 of the gear wheel set 35 meshes with a second wheel 34, referred to as the second drive wheel, which drives the karussel 1 via a first axial pinion 18.

To control the rotation of the carriage 2 and prevent it from rotating freely, the karussel 1 comprises gear trains 40 for retaining the carriage 2. The retaining gear trains 40 are arranged outside the carriage 2 of the karussel 1 so as to mesh with the second wheel 34 and with the carriage 2.

The retaining gear trains 40 comprise a second wheel set 39 with two parallel wheels, the two wheels comprising an upper wheel 41 and a lower wheel 42. The retaining gear trains 40 comprise a third connecting wheel set 43 combining a wheel 44 and a gear pinion 45 which are stacked.

The upper wheel 41 of the two-wheel wheel set 39 meshes with an outer peripheral toothing 46 of the carriage 2, whereas the lower wheel 42 of the two-wheel wheel set 39 meshes with the wheel 44 of the third connecting wheel set 42, and the pinion 45 of the third connecting wheel set 43 meshes with the second gear wheel 34.

The retaining gear trains 40 prevent the carriage 2 from rotating faster than desired. The retaining gear trains 40 connect the rotation of the carriage 2 with the fourth wheel.

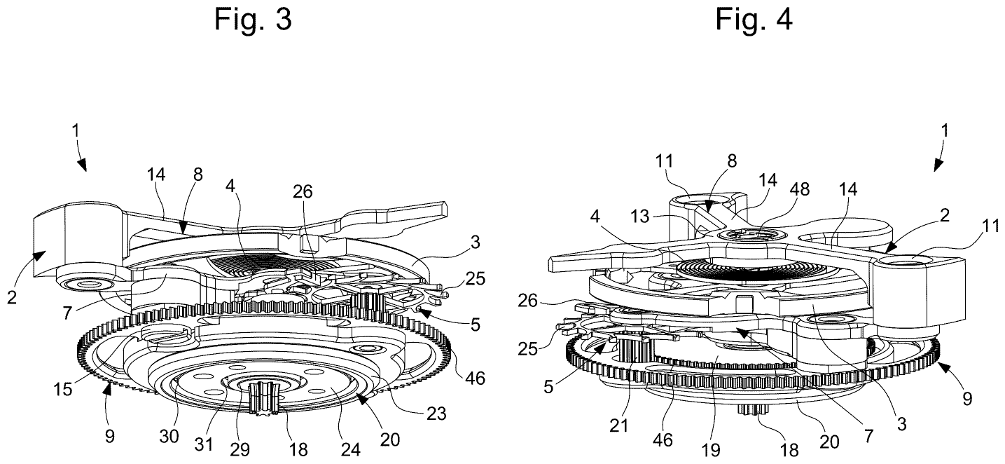

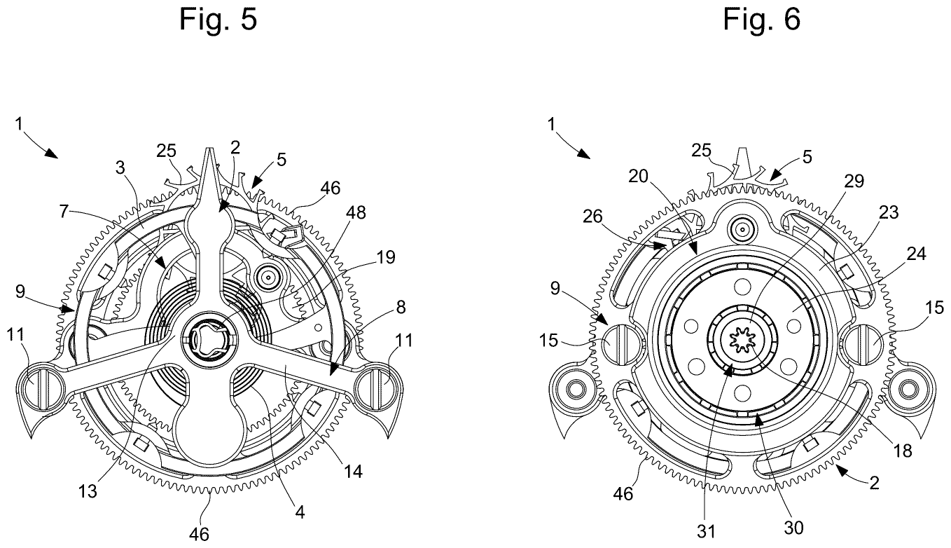

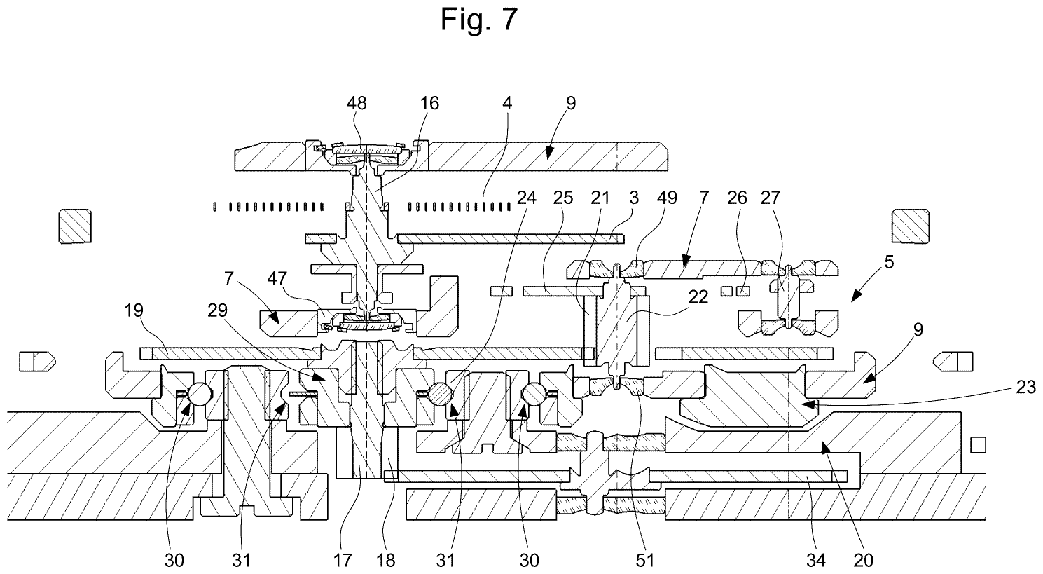

In FIGS. 3 to 7, the karussel 1 includes a karussel carriage 2, inside which a mechanical resonator with an inertial mass 3, a guide and a resilient return element 4, as well as a Swiss lever escapement mechanism 5 are arranged.

The karussel carriage 2 comprises an upper armature 8 and a lower armature 9 assembled together with screws 11, of which there are two in this case. The mechanical resonator with the inertial mass 3, the guide and the resilient return element, as well as the escapement mechanism are suspended between the upper armature 8 and the lower armature 9.

According to a non-limiting alternative embodiment, the lower armature 9 is a large circular wheel, provided in this case with the peripheral toothing 46. The upper armature 8 in this case comprises four arms 14 extending from a central junction 13, the arms 14 extending from the central junction. The three posts 32 are angularly distributed around the periphery of the karussel carriage 2, so as to connect the circular wheel to each arm 14.

In FIGS. 3 to 7, the karussel 1 includes an intermediate bar 7 arranged between the upper armature 8 and the lower armature 9. The upper armature 8 is assembled to the intermediate bar 7 by first screws 11, of which there are two in this case, which are arranged at the end of two arms 14 of the upper armature 8. The lower armature 9 is assembled to the intermediate bar 7 by second screws 15, of which there are two in this case, which are arranged on two opposite sides of the large wheel of the upper armature 8.

The inertial mass 3 is an annular balance arranged on a first axial arbor 16 disposed in the middle of the karussel carriage 2. The first axial arbor 16 is substantially perpendicular to the second plane of the inertial mass.

The balance is disposed in the upper part of the karussel carriage 2 so that it is visible from the outside. The inertial mass 3 and the first axial arbor 16 are arranged between the intermediate bar and the upper armature 8.

The balance is configured to perform a rotary oscillatory motion about the first radial arbor 16 within the karussel carriage 2 at a predetermined frequency. The first axial arbor 16 is held by bearings 47, 48 in the intermediate bar 7 and in the upper armature 8.

To actuate the mechanical resonator, a second axial arbor 17, substantially collinear with the first axial arbor 16, is disposed beneath the first axial arbor 16. The second axial arbor 17 partially extends beneath the karussel carriage 2. The first axial pinion 18 is integral with the second axial arbor 17 at the centre thereof, is coaxial with the balance, and is arranged beneath the karussel carriage 2.

An intermediate wheel 19 is integral with the second axial arbor 17 beneath the balance in the karussel carriage 2. The intermediate wheel 19 meshes with an escape pinion 21 arranged on a third radial arbor 22, which is substantially parallel to the axial arbors 16, 17. The third radial arbor 22 is arranged in the karussel carriage 2. The third radial arbor 22 also holds an escape wheel 25, which is disposed above the escape pinion 21. The third radial arbor 22 is held by bearings 49, 51 in the intermediate bar 7 and in the lower armature 9.

The escape wheel 25 cooperates with a Swiss lever 26 disposed perpendicularly between the first axial arbor 16 and the periphery of the escape wheel 25. The lever 26 comprises an elongate body with a fork at a first end, the fork being configured to cooperate with a pin of the first axial arbor 16, which is linked to the movement of the balance. The second end of the lever 26 includes two pallets arranged to cooperate with the escape wheel 25, alternately blocking the rotation thereof, so as to cause it to rotate in steps. The lever 26 is carried by a fourth radial arbor 27 arranged in the karussel carriage 2 between the first axial arbor 16 and the third radial arbor 22.

Turning the first axial pinion 18 actuates the escape wheel 25, the lever 26 and the movement of the balance, via the intermediate wheel 19 and the escape pinion 21, which rotate the third radial arbor 22. The rotation of the carriage 2 is also actuated when the first axial pinion 18 is rotated, as the force applied to the first axial pinion 18 is divided between the escapement mechanism and the rotation of the carriage 2 of the karussel 1.

The karussel carriage 2 is mounted so that it can rotate about an axis of rotation by means of a first ball bearing 31. Moreover, the karussel 1 comprises a second ball bearing 31 for actuating the escapement mechanism 25.

According to the invention, the first ball bearing 30 and the second ball bearing 31 are arranged at substantially the same height, i.e. in the same plane. This reduces the thickness of the karussel 1 compared with a conventional karussel.

Moreover, the second bearing 31 is arranged concentrically inside the first ball bearing 30. Preferably, the first ball bearing 30 and the second ball bearing 31 are coaxial.

To this end, the karussel 1 comprises a bearing support 20 arranged under the karussel carriage 2, the bearing support 20 being provided with the first ball bearing 30 and the second ball bearing 31. The bearing support 20 is intended to be at least partially fastened in the horological movement 10, when the karussel 1 is mounted, for example on a bar or directly on the plate.

The bearing support 20 comprises a first element 23, preferably external, intended to be mounted integral with the carriage 2. The first element 23 is assembled to the lower armature 9 of the carriage 2, in this case under the large wheel, for example by one or more screws, or by fitting studs into orifices.

The bearing support 20 comprises a second element 24, preferably an intermediate element, intended to be mounted integral with the plate of the movement 10. The second element 24 can be fastened to a bar of the plate by conventional fastening means.

The bearing support 20 comprises a third element 29, preferably internal, intended to be mounted integral with the second axial arbor 17 actuating the escapement mechanism 25. The second axial arbor 17 is fitted through the third element 29, preferably at its centre. The second axial arbor 17 is held by the third element 29 partly in the karussel carriage 2, between the intermediate bar 7 and the lower armature 9, and partly below the karussel carriage 2.

The three elements 23, 24, 29 are, for example, substantially circular, in the shape of rings.

The first element 23 and the second element 24 are movably connected to each other by the first ball bearing 30, whereas the third element 29 and the second element 24 are movably connected to each other by the second ball bearing 31.

Each ball bearing comprises movable balls arranged between the first element 23 and the second element 24 for the first ball bearing 30, and between the third element 29 and the second element 24 for the second ball bearing 31.

When the karussel 1 is mounted in the movement 10, the first element 23 can move relative to the plate, as it rotates with the carriage 2. The second element is fixed relative to the plate, as it is assembled in the movement 10. The third element 29 can move relative to the plate, as it rotates with the second axial arbor 17 of the karussel.

The first element 23, the second element 24 and the third element 29 are preferably arranged in the same plane as the first ball bearing 30 and the second ball bearing 31.

Thus, thanks to the second ball bearing 31 and to the bearing support 20, the second axial arbor 17 can rotate relative to the plate, when the first axial pinion 18 is driven by the second wheel 34. Moreover thanks to the first ball bearing 30 and to the bearing support 20, the karussel carriage 2 can rotate relative to the plate.

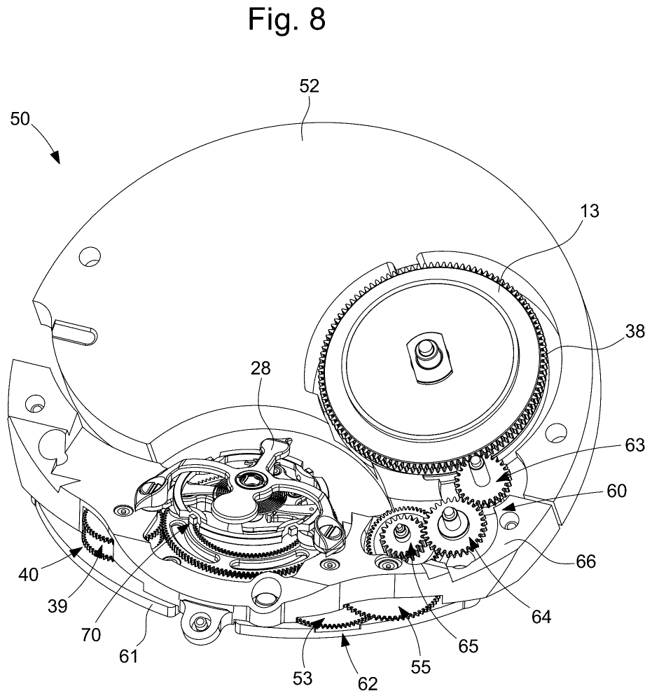

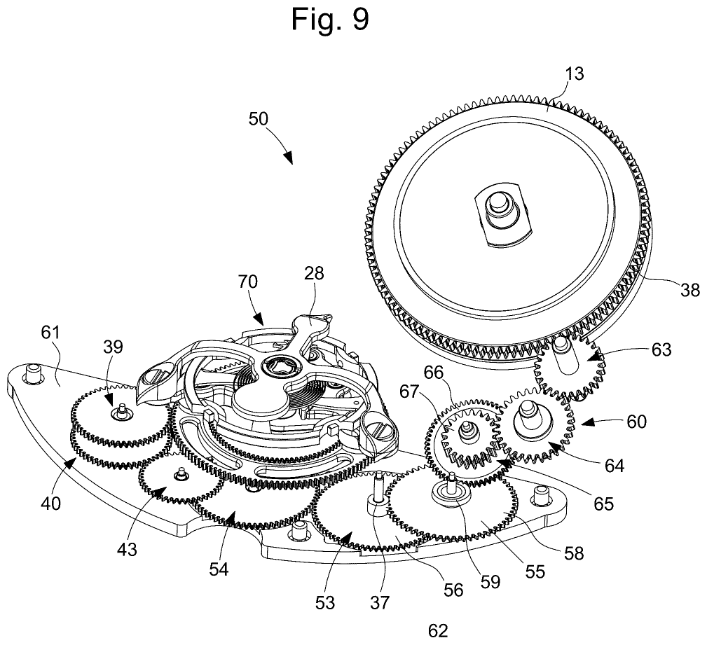

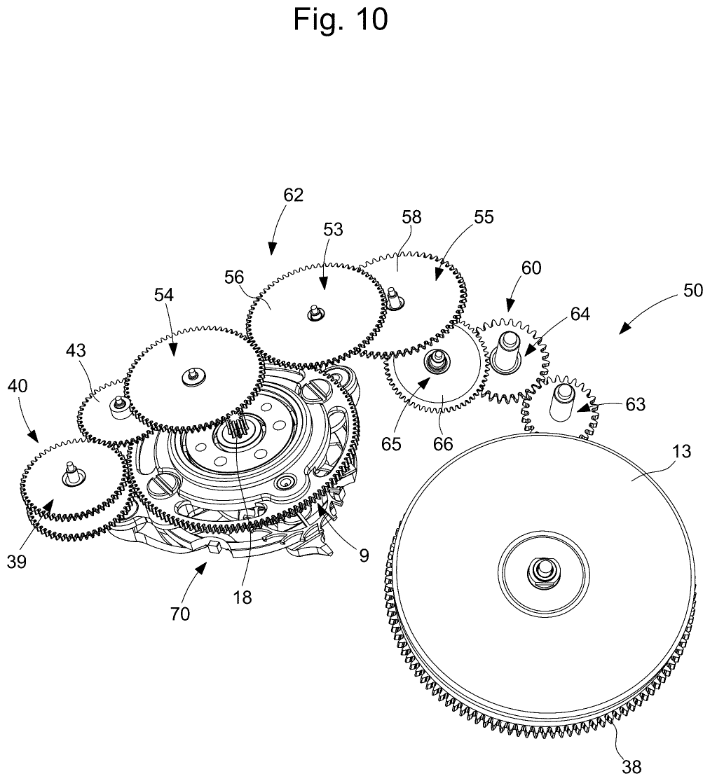

FIGS. 8 to 10 show a second embodiment of a horological movement 50 comprising such a karussel 70, and in which the karussel 70 is mounted at an angle to the plate 52.

In other words, unlike in the first embodiment of the horological movement 10, where the axis of rotation of the karussel 70 forms an angle with the plane of the plate of substantially equal to 90°, the angle here is less than 90°. The angle is, for example, between 20° and 70°, preferably between 30° and 60°.

To this end, the horological movement comprises a plate 52 provided with a barrel 13, a first inclined bar 61 to support the karussel 70, retaining gear trains 40 and a gear train 62. The plane in which the first inclined bar 61 lies forms an angle that is not 0° with the plane in which the plate 52 lies, and which angle is substantially equal to the angle formed between the axis of rotation of the karussel and the plate 52. The first inclined bar 61 is assembled to the plate 52 by conventional fastening means.

A second inclined bar 66 is arranged above the first inclined bar 61, to suspend the gear train 62, which is arranged between the two inclined bars 61, 66.

The configurations of the karussel 70, the gear train 62 and the retaining gear trains 40 are substantially identical to those of the first embodiment.

According to the invention, the karussel 70 thus comprises a first ball bearing 30 and a second ball bearing 31 arranged substantially in the same plane. Such a karussel 70 has a thickness that can be limited, and is particularly appropriate in the case of an inclined karussel to avoid excessive dimensions. This is because an inclined karussel 70 takes up more space in terms of height than a flat karussel.

In this second embodiment, the upper armature 28 of the karussel 70 is curved to reduce the volume of the karussel 70. Thus, the arms of the upper armature 28 are substantially curved towards the lower armature 9, from the central junction to the periphery of the karussel 70.

This configuration of the upper armature 28 also reduces the thickness of the horological movement 50, as an inclined karussel 70 also takes up a larger height due to the size of the diagonal carriage. As a result, a curved upper armature 28 reduces the height of the inclined karussel 70.

The inclined bar 61 is assembled to the plate 52 such that it has a downward slope from the outside of the horological movement towards the centre of the plate 52. Thus, the karussel 70 is inclined towards the inside of the horological movement 50.

The gear train 62 comprises a third gear wheel 54, a third gear wheel set 53 and a fourth gear wheel set 55 combining a wheel 56, 58 and a gear pinion 57, 59 which are stacked.

A wheel 56 of the third gear wheel set 53 meshes with the third wheel 54, referred to as the second drive wheel, which drives the karussel 70 via the first axial pinion 18.

The wheel 58 of the fourth wheel set 55 meshes with the pinion 37 of the third wheel set 53, whereas the pinion 59 of the fourth wheel set 55 meshes with additional gear trains 60 connecting the barrel 13 to the gear train 62.

The additional gear trains 60 are mounted on the plate 52, so that the additional gear trains 60 are inclined relative to the gear train 62.

The additional gear trains 60 comprise a fourth gear wheel 63, a fifth gear wheel 64 and a fifth gear wheel set 65 combining a wheel 66 and a gear pinion 67 which are stacked. The fourth wheel 63 is driven by the outer toothing 38 of the barrel 13, and thus meshes with the fifth wheel 64.

The fifth wheel 64 meshes with the gear pinion 67 of the fifth gear wheel set 65.

Finally, the wheel 66 of the fifth gear wheel set 65 meshes with the pinion 59 of the fourth gear wheel set 55 of the gear train 62.

Thanks to the additional gear trains 60 and to the gear train 62, the force of the barrel 13 is thus transmitted to the karussel 70.

Moreover, the fifth gear wheel set 65 is at an angle to the fourth gear wheel set 55. This is because the fifth gear wheel set 65 is mounted on the plate 52, whereas the fourth gear wheel set 55 is mounted between the bars 61, 66.

The toothings of the wheel of the fifth gear wheel set 65 and of the pinion of the fourth wheel set 55 are configured to cooperate with each other, for example with an orientation and cutting specific to the inclination between the fifth gear wheel set 65 and the fourth wheel set 55.

It goes without saying that the invention is not limited to the embodiments described with reference to the figures and alternatives can be considered without leaving the scope of the invention.

1. A karussel for a horological movement, the karussel comprising an inertial mass, a guide and a resilient return element for returning the inertial mass, configured to cause it to oscillate in a plane, as well as an escapement mechanism cooperating with the inertial mass, the karussel comprising a carriage intended to be rotatable, the inertial mass, the guide, the resilient return element and the escapement mechanism being arranged inside the carriage, the karussel comprising a first ball bearing allowing the carriage to rotate, when mounted in a horological movement, and a second ball bearing allowing the escapement mechanism to be actuated, wherein the first ball bearing and the second ball bearing are arranged substantially in the same plane.

2. The karussel according to claim 1, wherein the first ball bearing and the second ball bearing are coaxial.

3. The karussel according to claim 2, wherein the second bearing is arranged concentrically inside the first ball bearing.

4. The karussel according to claim 1, wherein the karussel comprises a bearing support that includes the first ball bearing and the second ball bearing.

5. The karussel according to claim 4, wherein the bearing support is arranged beneath the carriage.

6. The karussel according to claim 4, wherein the carriage comprises an upper armature and a lower armature, the bearing support being arranged beneath the lower armature.

7. The karussel according to claim 1, wherein the bearing support comprises a first element, intended to be mounted integral with the carriage.

8. The karussel according to claim 7, wherein the bearing support comprises a second element, intended to be mounted integral with the plate of the movement.

9. The karussel according to claim 8, wherein the bearing support comprises a third element, intended to be mounted integral with an arbor actuating the escapement mechanism.

10. The karussel according to claim 9, wherein the first element and the second element are connected via the first ball bearing.

11. The karussel according to claim 10, wherein the third element and the second element are connected via the second ball bearing.

12. The karussel according to claim 9, wherein the first element, the second element and the third element are arranged in the same plane as the first ball bearing and the second ball bearing.

13. A horological movement comprising a plate configured to support the other parts of the movement, the horological movement comprising drive means provided with a gear train, and a karussel according to claim 1.

14. The horological movement according to claim 13, wherein the karussel is mounted at an angle to the plate.

15. A timepiece comprising a horological movement according to claim 13.
